(19) United States
(12) Patent Application Publication
(10) Pub. No.: US 2006/0103949 A1
(43) Pub. Date: May 18, 2006

(54) Lens drive mechanism and torque limiter mechanism

(75) Inventor: Atsushi Fuchimukai, Tochigi (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/280,241

(22) Filed: Nov. 17, 2005

(30) Foreign Application Priority Data
Nov. 17, 2004 (JP) P2004-333688

(51) Int. Cl. G02B 15/14

(52) U.S. Cl. 359/694

(57) ABSTRACT

A torque limiter mechanism includes an input part, an output part, and a transmitting member. The transmitting member transmits rotation of the input part to the output part. One of the input and output part includes a ring member that is provided with pairs of stop sections. The remaining one of the input and output part includes a shaft. The transmitting member includes a squeezing section that contacts the shaft, and a pair of legs that is engageable with a pair of stop sections. When a torque exceeding a predetermined value is induced between the input and output parts, a space between the legs is varied, so that a retaining force of the squeezing section against the shaft is released or reduced. Further, each of the pairs of the stop sections is preset to different distances.

### BACKGROUND OF THE INVENTION

1. Field of the Invention

The present invention relates to a lens drive mechanism and a torque limiter mechanism for an interchangeable lens of an AF camera.

2. Description of the Related Art

Lens-drive mechanisms provided on a body of a camera having interchangeable lenses, are known. The lens drive mechanism is provided with an AF motor, an output shaft, a power transmission system, and an encoder. The output shaft engages with a lens barrel when the lens barrel are mounted on the camera body, and transmits the drive force (torque) of the AF motor to the lens barrel. The power transmission system connects the AF motor to the output shaft, so that the rotation of the AF motor is reduced and transmitted to the output shaft. The encoder includes a photointerrupter and a pulser and the rotation of the output shaft is detected by detecting the rotation of the pulser. Further, the power transmission system is equipped with a torque limiter mechanism that limits torque output from the output shaft (refer to the Japanese Unexamined Patent Publication No. 01-304415).

As a conventional torque limiter mechanism applied in the lens-drive mechanisms, a type using a clutch spring (a torsion coil spring) is known. The torque limiter mechanism includes a clutch spring of which both ends protrude outside, and this stop sections that are engageable with both the ends of the clutch spring. The space between the stop sections is preferably identical to the space between both the ends of the clutch spring.

However, dimensions of the clutch spring include dispersion (such as tolerance relating to the inner diameter, and the space and angle between both the ends), so that the space between both the ends of the clutch spring may be bigger or smaller than the space between the stop sections.

Therefore, in the conventional lens-drive mechanism, if the space between both the ends of the clutch spring is smaller than the space between the stop sections, there exists a gap between the stop section and the end of the clutch spring when the clutch spring is installed. When the gap is big, the fit of the clutch spring deteriorates so that an AF control operation becomes unstable, such as when rotation of an AF motor is reversed. Further, an error is generated between signals output from an encoder and displacement of an AF lens, so that the AF control operation cannot be carried out precisely.

Further still, when the space between both ends of the clutch spring is bigger than the space between the stop sections, both ends of the clutch spring are compressed by the pair of the stop members and each of the ends approaches each other when the clutch spring is installed, so that the clutch spring is expanded (i.e., the diameter is increased) and rotation cannot be transmitted to a shaft since slipping is induced.

### SUMMARY OF THE INVENTION

An object of the present invention is to provide a simple structured lens-drive mechanism and torque limiter mechanism (e.g., a structure which requires a small number of components) that can eliminate ricketyness of a transmitting member in the torque limiter mechanism, and that can securely transmit driving force of a drive source when it is required.

According to the present invention, a lens-drive mechanism for a camera is provided. The les-drive mechanism comprises a drive source, an output shaft, and a power transmission system.

The output shaft is rotatable and provided with a joint which is connected to a lens barrel attached to a camera body. The output shaft is rotated by a driving force from the drive source and transmits the rotation to the lens barrel through the joint.

The power transmission system transmits the driving force of the drive source to the output shaft. The power transmission system includes a torque limiter mechanism that limits torque output from the output shaft. The power transmission system further includes a ring member through which the output shaft is inserted.

The torque limiter mechanism includes an elastic transmitting member and a receiving portion. The transmitting member is coiled around the output shaft to contact the output shaft and has two ends that protrude outside with respect to the output shaft. The receiving portion is provided on the ring member and receives at least a part of the transmitting member.

The receiving portion has a plurality of pairs of stop sections that are arranged along a periphery of the ring member. The pairs of stop sections are engageable with both ends of the transmitting member and spaces between each of the pairs of stop sections are different.

The transmitting member is arranged so that both the ends of the transmitting member are engageable with a pair of stop sections selected from the plurality of pairs of stop sections. The output shaft is connected to the ring member through the transmitting member and rotates with the ring member.

Transmission of rotation of the output shaft is controlled when the transmitting member is expanded and one of the stop members abuts against one of the ends, when rotational speed of the output shaft is reduced or when the rotation of the output shaft is stopped, as a result of a force which is applied to the output shaft from the lens barrel side exceeding a predetermined value.

According to another aspect of the invention, a torque limiter mechanism is provided that includes an input part, an output part, and a transmitting member.

The transmitting member transmits rotation of the input part to the output part. One of the input part and the output part includes a ring member that is provided with a plurality of pairs of stop sections which are arranged along a periphery of the ring member. The other one of the input part and the output part includes a shaft inserted into the ring member.

The transmitting member includes a squeezing section that contacts the shaft, and a pair of legs that is engageable with a pair of stop sections which is selected from the plurality of pairs of stop sections. When a torque between the input and output parts exceeds a predetermined value while one of the legs is engaged with one of the stop sections which is selected from the pairs of stop sections, a space between the legs is varied, so that a restraining force of the squeezing section pinching the shaft is released or reduced. Further, each of the pairs of the stop sections has different space sizes.

### BRIEF DESCRIPTION OF THE DRAWINGS

The objects and advantages of the present invention will be better understood from the following description, with reference to the accompanying drawings in which:

FIG. 1 is a front view of a camera body of a single-lens reflex camera having interchangeable lenses, to which an embodiment of a lens-drive mechanism of the present invention is applied;

FIG. 2 is a front view of the camera that illustrates the inner configuration of the camera body shown in FIG. 1;

FIG. 3 is a perspective view of the lens drive mechanism of the present embodiment of the invention;

FIG. 4 is an exploded perspective view of the lens drive mechanism of the present embodiment;

FIG. 5 is a sectional view of the lens drive mechanism of the present embodiment; and

FIG. 6 is a perspective of a worm wheel of the lens-drive mechanism shown in FIGS. 3-5;

FIG. 7 is a rear view (viewed from the right hand side of FIG. 4) of a worm wheel of the lens-drive mechanism shown in FIGS. 3-5; and

FIG. 8 is a rear view showing an assembly arrangement of a worm wheel and a clutch spring, where components other than the worm wheel and the clutch spring are removed so as to make the arrangement clearly understood.

### DESCRIPTION OF THE PREFERRED EMBODIMENTS

A lens-drive mechanism (an AF lens-drive block) and a torque limiter mechanism of the invention are described below with reference to the preferred embodiment shown in the drawings.

Note that, in the following description, a lens-drive mechanism having or provided with a torque limiter mechanism will be explained as an example.

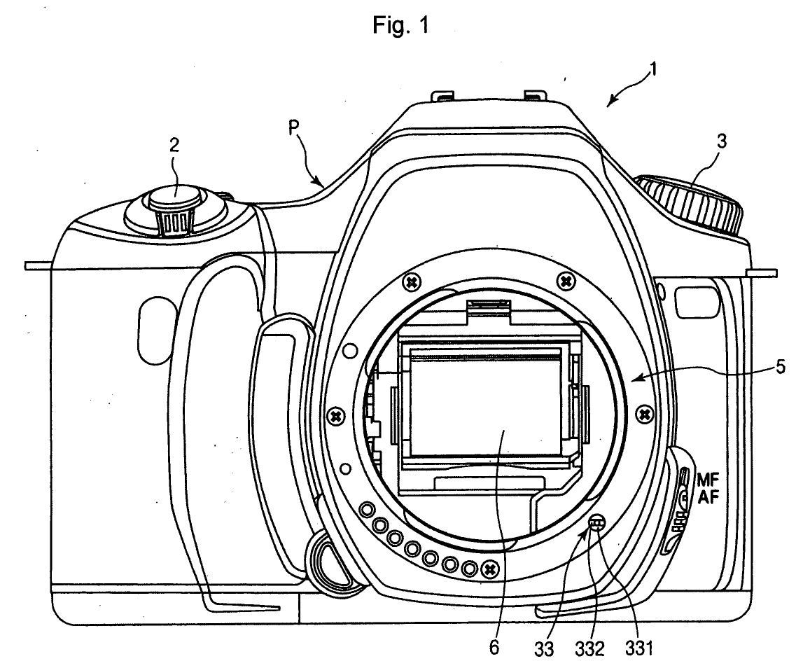

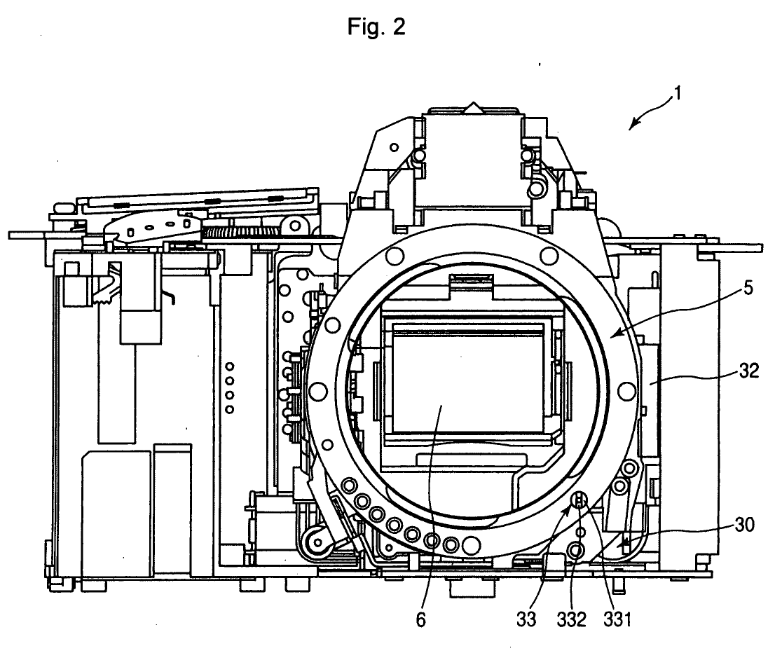

FIG. 1 is a front view of a body of a lens interchangeable single-lens reflex camera to which an embodiment of a lens-drive mechanism (an AF lens-drive block) of the present invention is applied. FIG. 2 is a front view of the camera that illustrates the inner configuration of the camera body shown in FIG. 1.

The camera body 1 illustrated in FIGS. 1 and 2 is a lens interchangeable single-lens reflex camera where a lens barrel (a photographing lens), which can be detachably mounted on the camera body 1, is removed.

As shown in FIG. 1, on an upper surface “P” of the camera body 1, a release button 2 is provided at about the left edge (in FIG. 1) and a mode dial 3 for selecting a mode from various modes is provided at about the right edge (in FIG. 1).

Further, a lens mount 5 for detachably attaching a lens barrel is provided in the middle of the front face of the camera body 1.

In the interior of the camera body 1, a quick return mirror 6 which is arranged on an optical axis of the lens barrel when a lens barrel is mounted, an imaging unit including a CCD (imaging device; not shown), and a shutter unit (not shown) arranged on a light receiving surface side of the imaging unit, are provided.

The camera body 1 further includes a controller (not shown) that integrally controls the camera body 1 and the lens barrel, an AF sensor (not shown), and a lens-drive mechanism 30 for driving the lens barrel, which is mounted on the camera body 1.

The lens-drive mechanism 30 includes an AF motor 32 and an output shaft 33 having an AF coupler 331 with a joint 332 on the tip, and so on, and is arranged inside the camera body 1 on the right-hand side in FIG. 2. The lens-drive mechanism 30 is arranged so that the rotational axis of the output shaft 33 is parallel with the optical axis of the mounted lens barrel (which is attached on the lens mount 5) and the AF coupler 331 penetrates the lens mount 5 to extend the joint 332 outside the surface of the lens mount 5. The details of the lens-drive mechanism 30 will be discussed later.

The controller controls the AF (auto focus) operation, photographing operation, and various types of operations based on the operations of operational switches. For example, operations of the AF motor 32 of the lens-drive mechanism 30, such as whether to start/stop rotation, and in which direction to rotate, and so on, are all controlled by the controller.

The AF sensor is a distance-measurement sensor that applies the so called phase difference detecting method. The AF sensor is provided with a CCD sensor, at a position optically identical with the light-receiving surface of the CCD of the imaging unit. The AF sensor outputs a signal regarding the focusing state inside a predetermined infocus detecting area, which is defined within the image photographing area (not shown), to the controller as an AF video signal. The controller calculates the defocus amount based on the AF video signals and calculates a lens drive direction and the amount of drive for the AF lens or the focusing lens (not shown) to be moved to a position where light rays made incident to the AF lens form an infocus image on an image focusing screen (not shown), based on the defocus amount and the specific lens data of the photographing lens of the lens barrel mounted on the lens mount 5, and then drives the AF motor 32 (AF drive operation) The driving force of the AF motor 32 is transmitted to a gear unit (not shown) through the joint 332, which extends out from the surface of the lens mount 5 of the camera body 1, and a joint provided on a mount of the lens barrel, so that the AF lens is driven or moved in an optical axis direction.

Next, the lens drive mechanism 30 (the AF lens-drive block) will be explained.

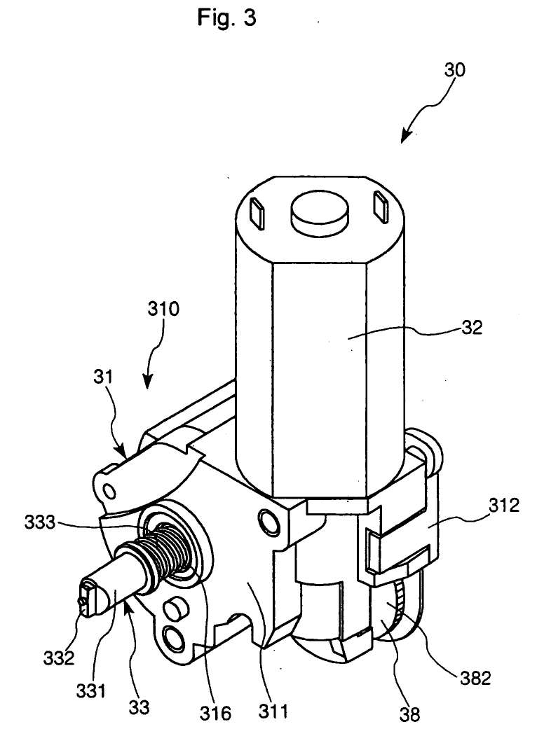

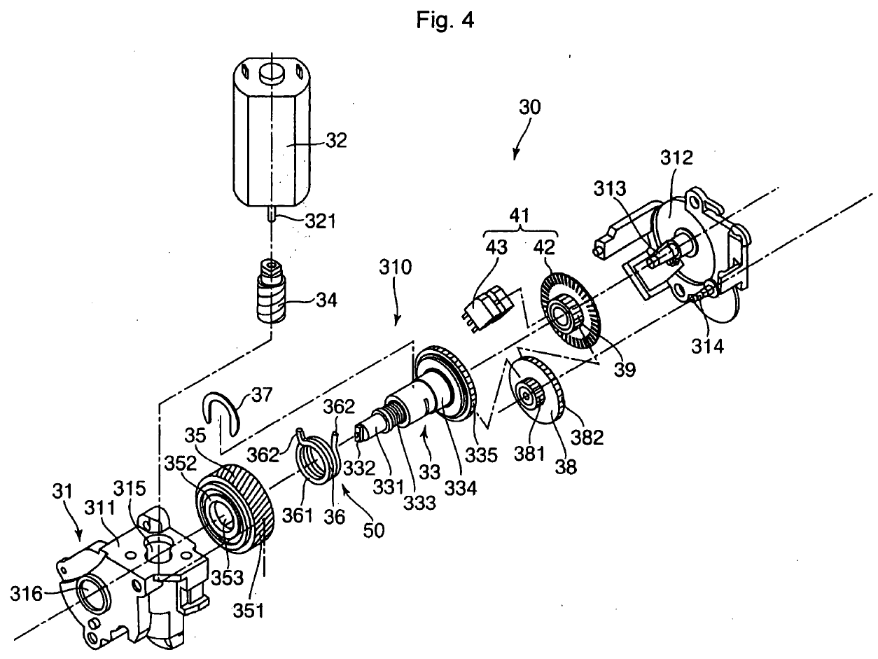

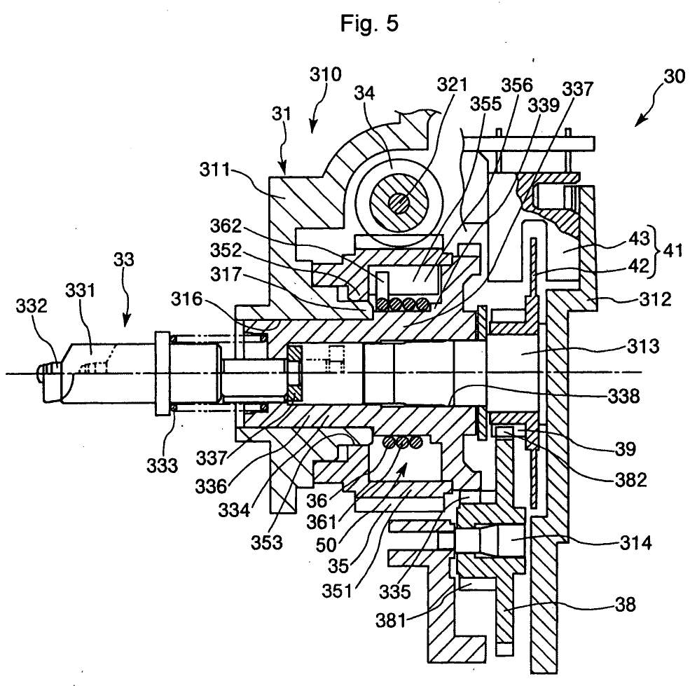

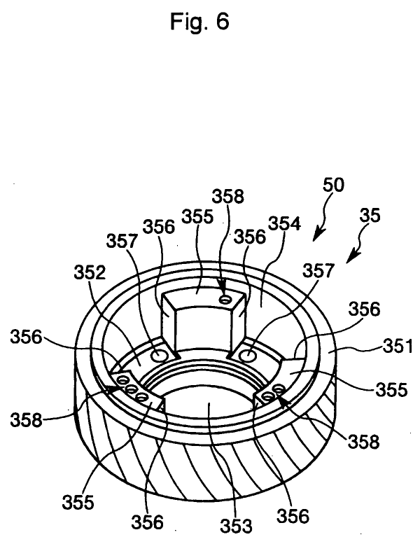

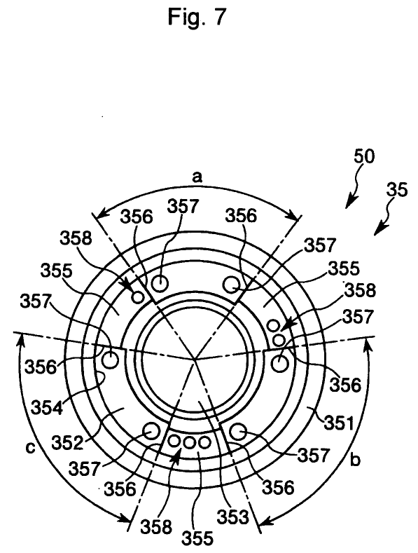

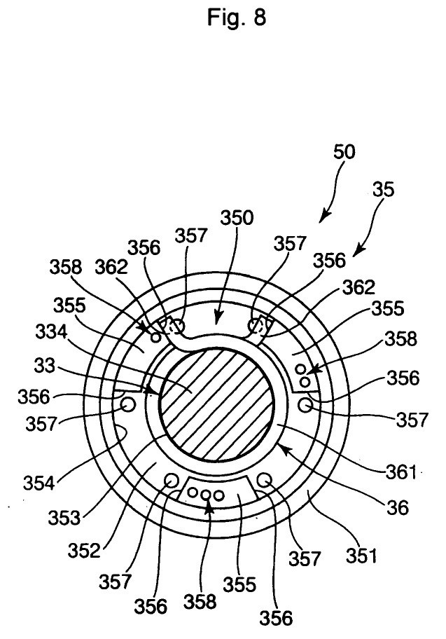

FIG. 3 is a perspective view of the lens drive mechanism of the present embodiment of the invention. FIG. 4 is an exploded perspective view of the lens drive mechanism of the present embodiment. FIG. 5 is a sectional view of the lens drive mechanism of the present embodiment. Further, FIG. 6 is a perspective view of a worm wheel of the lens-drive mechanism, which is shown in FIGS. 3 to 5. FIG. 7 is a rear view (a drawing viewed from the right hand side of FIG. 4) of the worm wheel of the lens-drive mechanism shown in FIGS. 3 to 5. FIG. 8 is a rear view that illustrates an arrangement of an assembly including a worm wheel 35 and a clutch spring 36, where components other than the worm wheel 35 and the clutch spring 36 are removed so as to make the arrangement clearly understood.

In FIG. 5, the sectional view (partly including outer profiles) above the centerline (indicated by a broken line) and the sectional view below the centerline show different sections having different angles of view. Further, in FIG. 5, a retaining ring 37 is not shown. Furthermore, the output shaft 33 is represented by a hatched portion, in FIG. 8, so as to indicate the relationship of the output shaft 33 to the other components.

As shown in the figures, the lens drive mechanism 30 is comprised of a body 310 of which the peripheral part is formed by a casing 31, and the AF motor (the driving source) 32. The casing 31 includes a front casing area 311 and a rear casing area 312. The AF motor 32 is fixed to the outside of the casing 31 with a rotational shaft 321 inserted inside the casing 31 through a hole 315 formed in the front casing area 311.

In FIG. 2, the AF motor 32 is arranged on the right hand side with the rotational shaft 321 aligned in the vertical direction. Namely, the AF motor 32 is arranged so that the rotational shaft 321 is perpendicular to the rotating axis of the output shaft 33 (which will be discussed later) or the rotational shaft 321 is perpendicular to the optical axis of the lens barrel mounted on the lens mount 5.

Thereby, the dimensions of the lens drive mechanism 30 in the direction of the rotating axis of the output shaft 33 can be reduced compared to the configuration where the rotational shaft 321 of the AF motor 32 is arranged in parallel to the rotating axis of the output shaft 33. Therefore, this configuration is very effective for a digital camera of which the length extending forward from a shutter unit is comparatively short.

Further, inside the casing 31 of the body 310, the output shaft 33, the worm wheel (a ring member) 35 which is inserted into the output shaft 33 via the clutch spring (a torsion coil spring) 36, a worm gear 34 which engages the worm wheel 35, the retaining ring 37 (the retaining spring 37 can be reduced), a double gear wheel 38, and an encoder (detecting device) 41, are provided. Note that, an elastic transmitting member is composed of the clutch spring 36.

The output shaft 33 includes the AF-coupler 331 (on the tip of which the joint 332 is formed for engaging with the joint provided on the lens barrel attached to the camera body 1 from the front side (from the left hand side of FIG. 4)), the coil spring (biasing member) 333, a retainer (a shaft member or an output member) 334 generally having a cylindrical outline, and a gear wheel 335 (provided on the rear end of the retainer 334). The fore end of the AF coupler 331 (left hand side in FIGS. 3 and 4) extends out from the casing 31 through the hole 316 formed on the front casing 311. The fore end side of the retainer 334 of the output shaft 33 is formed as a small diameter section 336 having a diameter smaller than the diameter of the base end side, and a small diameter section 336 is inserted into the hole 316 of the front casing 311. Further, the gap between the outer surface of the small diameter section 336 and the inner surface of the hole 316 of the front casing 311 is reduced and is filled with lubricant, so that the output shaft 33 is rotated smoothly.

The coil spring 333 is compressed a little and interposed between the AF coupler 331 and the retainer 334. The AF coupler 331 is suitably biased by the coil spring 333 in a direction that separates the joint 332 from the retainer 334. The base end of the AF coupler 331, which is opposite to the joint 332, is movable along the axis of the output shaft 33, relatively against the retainer 334, due to the coil spring 333. Further, a ring 337 is fixed to the base end of the AF coupler 331, so that the AF coupler 331 is retained so as not to separate from the retainer 334 in a situation where the joint 332 is positioned apart from the retainer 334 by the maximum amount (an extended position). Note that, the AF coupler 331 and the retainer 334 are engaged at the base end of the AF coupler 331, and the relative rotation between the AF coupler 331 and the retainer 334 is restricted, but allowing integrated rotation.

As described above, the AF coupler 331 is suitably biased in the direction which separates the AF coupler 331 from the retainer 334 by the biasing force of the coil spring 333. When the lens barrel is not attached to the lens mount 5, the AF coupler 331 is in the extended position. On the other hand, when attaching a non AF lens barrel, a different type of AF lens barrel that is not able to engage with the joint 332 of the AF coupler 331 (such as a lens barrel provided by another maker) to the lens mount 5, or when detaching a lens barrel that engages with the joint 332 of the AF coupler 331 from the lens mount 5, the AF coupler 331 is pressed and moved backward, so that the AF coupler 331 is retracted inside the surface of the lens mount 5.

Further, shafts 313 and 314 are provided inside the rear casing 312, and both the shafts 313 and 314 are parallel with each other. A hole 338 having a circular section is formed on the retainer 334 of the output shaft 33 along the axis of the output shaft 33. The base end side (right hand side in FIGS. 3-5) of the retainer 334 of the output shaft 33 is inserted into the shaft 313 and is rotatably supported by the shaft 313. Further, the gap between the outer surface of the shaft 313 and the inner surface of the hole 338 of the retainer 334 is reduced and is filled with lubricant, so that the output shaft 33 is rotated smoothly.

Further, the output shaft 33 penetrates the worm wheel 35. The worm wheel 35 is positioned at the base end of the retainer 334 of the output shaft 33, and movement along the rotational axis of the output shaft 33 is restricted by the retaining ring 37 attached or fixed on the retainer 334.

Inside the worm wheel 35, there is provided a torque limiter mechanism (clutch mechanism) 50, which limits the output torque of the output shaft 33, so that rotational force (rotational motion) of the worm wheel 35 is transmitted to the output shaft 33 through the torque limiter mechanism 50.

Namely, when the AF motor 32 is driven and thus the rotational shaft 321 is rotated in a predetermined direction, the drive force (rotational force) is transmitted to the output shaft 33 via the worm gear 34, worm wheel 35, and the clutch spring 36, so that the output shaft 33 is rotated in the predetermined direction. Further, during the above power transmission, the rotational speed of the AF motor 32 is reduced by the worm gear 34 and the worm wheel 35.

Further, when the rotational shaft 321 of the AF motor 32 is rotated in the opposite direction to the above-mentioned direction, the drive force (rotational force) is transmitted to the output shaft 33 via the worm gear 34, worm wheel 35, and the clutch spring 36, so that the output shaft 33 is rotated in the opposite direction to the above predetermined direction.

Therefore, the worm gear 34, the worm wheel 35, and the clutch spring 36 comprise a power transmission system that transmits the drive force (rotational force) of the AF motor 32 to the output shaft 33. Note that, a description of the torque limiter mechanism 50 will be given later.

As described above, since the main part of the power transmission system of the present lens-drive mechanism 30 is configured by the worm gear 34 and worm wheel 35, the drive force of the AF motor 32 can be transmitted to the output shaft 33 while reducing the rotational speed by a large gear ratio compared to a system using normal gear wheels.

The double gear wheel 38 includes a gear wheel 381 and a gear wheel 382 which adjoin and are integrated together coaxially. The gear wheel 381 has a smaller diameter than that of the gear wheel 382 and the gear wheel 335. The double gear 38 is inserted into the shaft 314 and is rotatably supported by the shaft 314.

Further, the encoder 41 comprises the pulser (rotating disk) 42, which rotates together with the output shaft 33, and a photointerrupter 43 having a light emitting device and light detecting device which are disposed face to face. The encoder 41 can detect the rotation of the output shaft 33 (the amount of rotation), i.e. the displacement of the AF lens, by detecting the rotation (the amount of rotation) of the pulser 42 by means of the photointerrupter 43.

The pulser 42 is a circular disk in which slits or notches having a predetermined width are formed along the periphery at a predetermined pitch. The pulser 42 is inserted into the shaft 313 and is rotatably supported by the shaft 313. Further, the pulser 42 is disposed on the backside of the output shaft 33 (the right hand side in FIG. 4). The photointerrupter 43 is arranged so that the peripheral part of the pulser 42 is positioned between the light emitting device and the light-detecting device.

Further, on a disk plane of the pulser 42, a gear wheel 39 is provided that coaxially rotates with the pulser 42 and has a diameter smaller than that of the gear wheel 382. The gear wheel 39 engages with the gear wheel 382 of the double gear wheel 38 and the gear wheel 381 of the double gear wheel 38 engages with the gear wheel 335 of the output shaft 33.

Signals from the photointerrupter 34 (or encoder 41), such as pulse signals (detected signals), are input to the controller and used in the above-discussed AF drive control.

When the AF motor 32 is actuated and thus the output shaft 33 is rotated, the rotational force of the output shaft 33 is transmitted to the pulser 42 through the gear wheels 335, 381, 382, and 39, so that the pulser 42 is rotated. At the same time, the rotational speed of the AF motor 32 is increased by the gear wheels 335, 381, 382, and 39.

Namely, a speed increasing gear train (rotational power transmission mechanism), which increases the rotational speed, is configured from the gear wheels 335, 381, 382, and 39.

As described above, the output shaft 33 and the pulser 42 are not directly connected to the lens-drive mechanism of the present embodiment, and the rotational force (or rotation) is transmitted from the output shaft 33 to the pulser 42 and increases the rotational speed by and through the gear wheels 335, 381, 382, and 39.

Further, the pulser 42 is arranged so that the rotational axis of the pulser 42 is coaxial with the rotational axis of the output shaft 33. Thereby, the pulser 42 can be positioned on the backside (the base end side) of the output shaft 33, so that the dimensions of the lens-drive mechanism 30 in a direction perpendicular to the rotational axis of the output shaft 33 (a radial direction of the pulser 42) can be reduced compared to when the pulser 42 is disposed at the lateral side of the output shaft 33 (when the rotational axis of the pulser 42 is arranged apart from the rotational axis of the output shaft 33). Further, the frontal projected area of the lens-drive mechanism 30 (the projected area onto a plane perpendicular to the rotational axis of the output shaft 33) can be reduced compared to when the rotational axes of the output shaft 33, the double gear 38, and the pulser 42 are arranged at positions corresponding to the vertices of a triangle, that is viewed from the front side of the output shaft 33, that is, in the direction along the rotational axis of the output shaft 33. Further, an exclusive shaft has not been separately provided for the pulser 42, and the shaft 313 of the output shaft 33 is also used as the shaft of the pulser 42 while efficiently using the space between the output shaft 33 and the rear casing 312 where the shaft 313 is provided, so that the size of the camera body 1 can be reduced.

Furthermore, the worm wheel 35 is arranged so that the rotational axis of the worm wheel 35 is coaxial with the rotational axes of the output shaft 33 and the pulser 42. Thereby, the dimensions of the lens-drive mechanism 30 in a direction perpendicular to the rotational axis of the output shaft 33 can be reduced compared to when the worm wheel 35 is disposed at the lateral side of the output shaft 33 (when the rotational axis of the worm wheel 35 is arranged apart from the rotational axis of the output shaft 33), so that the size of the lens-drive mechanism 30 can be further reduced.

Next, the structure of the torque limiter 50 will be explained.

As shown in FIGS. 4 to 8, the torque limiter mechanism 50 is provided inside the worm wheel 35.

Namely, the torque limiter mechanism 50 is comprised of the clutch spring 36 installed inside the worm wheel 35 and a receiving portion 350 which is formed inside the inner periphery of the worm wheel 35 and which receives the clutch spring 36.

The clutch spring 36 includes a squeezing section (ring section) 361, which is coiled around the retainer 334 of the output shaft 33 so as to pinch or squeeze the retainer 334. The clutch spring 36 has a ring shaped profile in a plan view, and a pair of legs 362, which protrude outside both ends of the squeezing section 361 toward a radial direction of the output shaft 33. The clutch spring 36 transmits the rotating force of the worm wheel 35 to the output shaft 33 by squeezing and retaining the retainer 334 of the output shaft 33. Further, the clutch spring 36 releases the rotational force transmitted from the AF motor 32 and rotational force due to the moment of inertia when the torque which affects the output shaft 33 is more than or equal to a predetermined value, such as when the rotation of the AF coupler 331 is forcibly stopped (when the rotation of the output shaft 33 is stopped) as a result of the AF lens inside the lens barrel arriving at either of the end points (limits) for the near side or the far side.

On the other hand, the worm wheel 35 has a peripheral sidewall 351 where teeth are formed on the outer periphery (i.e., the peripheral sidewall 351 functions as a gear), a base plate 352 having a hole 353 through which the output shaft 33 is inserted, and a plurality of protuberances 355 which protrude from the inner face 354 of the peripheral sidewall 351 toward the center (in the present embodiment the number of the protuberances is three). The receiving portion 350, which receives the clutch spring 36, is mainly comprised of these protuberances 355.

Further, both ends or end faces (abut faces) 356 of the protuberances 355 in a circular direction of the worm wheel 35 form stop sections that engage or that are engageable with the leg 362 of the clutch spring 36 and are used to limit the position of the legs 362. Thereby, a pair of stop members, which is arranged in a circular direction of the worm wheel 35, and which engage or are engageable with the pair of legs 362 of the clutch spring 36, comprises the end faces 356 of two neighboring protuberances 355 or a pair of end faces 356 which face each other.

The clutch spring 36 is installed inside the inner surface of the peripheral sidewall 351 while the squeezing section 361 pinches or squeezes the retainer 334 of the output shaft 33. Further, the pair of legs 362 is positioned between two oppositely facing end faces 356 of two neighboring protuberances 355 and their positions are fixed by the end faces 356.

Further, the clutch spring 36 is arranged so that the squeezing section 361 is positioned between a ring shaped convex portion 339 (formed on the base end of the retainer 334) and a ring shaped protuberance 317 (formed on the front casing 311). Namely, the protuberance 356 and the convex portion 339 engage with the clutch spring 36 so as to limit the movement of the clutch spring 36 along the axial direction of the output shaft 33, thus the above structure prevents the clutch spring 36 dropping off the retainer 334.

Note that, the clutch spring 36 can be situated such that one of, or both of, the legs 362 do not engage with the end faces 356, however, the leg(s) 362 will be engaged with the end face 356 when the lens-drive mechanism 30 is actuated.

As shown in FIG. 7, spaces (an angle) between each pair of the above-mentioned three pairs of end faces (the stop members) 356, which oppositely face each other, are all preset as different values (each space is different from another space). As in the example in the figure, center angles of each of the pairs of the end faces 356 are preset as “a”, “b”, and “c” (a<b<c), respectively. Further, as shown in FIG. 8, the clutch spring 36 is arranged so that the pair of legs 362 is disposed between a pair of end faces 356 that is selected from the above-mentioned three pairs of the end faces 356. Namely, the legs 362 are disposed between the pair of the end faces 356 which has the optimum center angle.

Here, in the torque limiter mechanism 50 that is shown in the figure as an example, the clutch spring 36 is preferably formed, so that the space between the legs 362, when the squeezing section 361 of the clutch spring 36 retains the retainer 334 of the output shaft 33, corresponds to the middle-sized center angle (b).

Further, due to the tolerance, such as the bore tolerance of the of the squeezing section 361 of the clutch spring 36 or the tolerance of the space (or the center angle) between the legs 362, the center angle between the legs 362 can be bigger or smaller than a target value (a set point) when the clutch spring 36 is coiled around the retainer 334 of the output shaft 33. When the center angle between the legs 362 is bigger than the target value, the pair of end faces 356 having the center angle “c” is selected, and the clutch spring 36 is arranged so that the pair of legs 362 is disposed between the above-selected end faces. On the other hand, when the center angle between the legs 362 is smaller than the target value, the pair of end faces 356 having the center angle “a” is selected, and the clutch spring 36 is arranged so that the pair of legs 362 is disposed between the above-selected end faces. Further, when the center angle between the legs 362 substantially coincides with the target value, the pair of end faces 356 having the center angle “b” is selected, and the clutch spring 36 is arranged so that the pair of legs 362 is disposed between the above-selected end faces.

Note that, in the present embodiment, three pairs of end faces (stop sections) 356, each having a different space or interval, are provided on the worm wheel (ring member) 35. However, the number of pairs of end faces (stop sections) is not restricted to three, the invention can include any number which is more than or equal to two.

The number of pairs of end faces (stop sections) 356, each having a different space, is preferably preset to 2-6, and more preferably, preset to 3-5.

Further, in the lens-drive mechanism 30, openings (windows) 357 are respectively formed on a base plate 352 of the worm wheel 35 at positions beside each of the end faces 356.

Thereby, one can easily verify the position of the legs 362 of the clutch spring 36 with respect to the pair of end faces 356 from the outside of the worm wheel 35 or from the base plate 352 side (lower side in FIG. 6). Namely, a verifying system for verifying the relative positions of the legs 362 to the end faces 356 is provided by the openings 357.

Note that, in the present embodiment, two openings 357 are provided for each pair of end faces 356. However, the number of openings for each pair of the end faces 356 is not restricted to two. The number can also be set to one.

Further, the windows of the verifying system are not restricted to the above-mentioned openings 357. The windows can also be formed from a light transparent member and the like.

Further, in the lens-drive mechanism 30, indexes 358 are provided on each of the protuberances 355 that indicate the order, or relation among the sizes of the space (center angle) between each pair of the end faces 356. Each of the indexes 358 is provided on a surface of the protuberances 355, which faces the side opposite to the base plate 352 (upper side in FIG. 6), in the vicinity of one end face 356 (on the side close to one end face 356).

For example, each of the indexes 358 comprises one concave notch, two concave notches, and three concave notches, respectively. An index having more concave notches than another indicates a pair of end faces 356 having a larger center angle. Namely, in the vicinity of the end face 356 that has the center angle “a” (the minimum center angle), the index 358 with one concave notch is provided to denote that the center angle is the smallest. Further, in the vicinity of the end face 356 that has the center angle “b” (the middle-sized center angle), the index 358 with two concave notches is provided to denote that the center angle is the second biggest size (middle-sized). Furthermore, in the vicinity of the end face 356 that has the center angle “c” (the maximum center angle), the index 358 with three concave notches is provided to denote that the center angle is the largest.

Thereby, one can easily recognize the order of the size of the space between each pair of end faces 356, so that the assembly efficiency is improved.

Next, a function of the torque limiter mechanism 50 will be explained.

While the AF lens inside the lens barrel, which is attached on the lens mount 5, is driven between the end point for the near side and the end point for the far side, the retainer 334 is normally squeezed and retained by the squeezing section 361 of the clutch spring 36, so that slip between the squeezing section 361 (worm wheel 35) and the output shaft 33 is prevented (the rotation of the worm wheel 35 is transmitted to the retainer 334). Namely, output shaft 33 is connected to the worm wheel 35 through the clutch spring 36, thus rotating with the worm wheel 35. Thereby, the rotational force of the AF motor 32 is securely transmitted to the output shaft 33.

On the other hand, when force (torque) from the lens barrel side that acts on the output shaft 33 surpasses a predetermined value and the rotational speed (or the number of revolutions per second) of the output shaft 33 decreases or ceases while the trailing leg 362 of the clutch spring 36 engages either of the end faces of the protuberance 355 inside the worm wheel 35, an end face 356 of a protuberance 355 inside the worm wheel 35 abuts against a leg 362 of the clutch spring 36, which is on the trailing side of the rotation, so that the trailing leg 362 is urged to the rotational direction and the space between two legs 362 is decreased. As a result, the squeezing section 361 of the clutch spring 36 is expanded (i.e., the diameter of the squeezing section 361 is increased) and the squeezing section 361 (worm wheel 35) starts to slip on the output shaft 33, so that the rotational force transmission from the worm wheel 35 to the output shaft 33 is decreased or stopped. Namely, the retaining force of the squeezing section 361 to pinch or squeeze the retainer 334 is released or reduced.

For example, when the AF lens inside the lens barrel reaches either of the end points for the near side or the far side, that is when the drive member of the AF lens inside the lens barrel reaches a limit of the drivable range, a load (in the direction opposite to the rotation of the lens-drive mechanism 30) acts on the output shaft 33 from the lens barrel side and rotation of the AF coupler 331 (output shaft 33) is forcedly stopped, so that the rotation of the squeezing section 361 of the clutch spring 36 is stopped.

On the other hand, the AF motor 32 continues to rotate, so that the rotation of the worm wheel 35 is continued. Thereby, a leg 362 of the clutch spring 36, which is on the trailing side of the rotation, engages with an end face 356 of the protuberance 355 of the worm wheel 35 and is urged in the rotational direction by the end face 356 and rotated with the worm wheel 35, while the other leg 362 of the clutch spring 36, which is on the leading side of the rotation, stops rotation with the squeezing section 361. Namely, the space between two legs 362 decreases and the squeezing section 361 of the clutch spring 36 is expanded (i.e., the diameter of the squeezing section 361 is increased), and thereby the squeezing section 361 (worm wheel 35) starts to slip on the output shaft 33, so that the output shaft 33 and the clutch spring 36 no longer rotate together with each other. Namely, although the AF motor 32 continues to rotate, only the worm wheel 35 and the clutch spring 36 are rotated, and the rotational force is not transmitted to the output shaft 33 or only a little bit of the rotational force is transmitted to the output shaft 33 (i.e., the most of the rotational force can be released).

Accordingly, damage to or destruction of each component, such as the worm gear 34, the worm wheel 35, the gear wheels 335, 381, 382, and 39 of the lens-drive mechanism 30, the AF lens, the AF lens drive member, and the gear unit inside the lens barrel, can be prevented while the AF drive operation is being carried out.

As described above, according to the lens-drive mechanism 30 of the present embodiment, a pair of the end faces 356 having the optimum space (center angle) between each of the end faces 356 can be selected from the plurality of pairs of end faces (stop sections) 356, three pairs in the embodiment, when assembling the torque limiter mechanism 50. Thereby, unsteadiness of the clutch spring 36 in the torque limiter mechanism can be prevented, and the driving force (rotating force) of the AF motor 32 can be securely transmitted to the output shaft 33 when it is required. Accordingly, the AF drive control operation can be precisely and securely carried out.

Further, the torque limiter mechanism can be made with a simple structure, without increasing the number of components.

Further, because the torque limiter mechanism 50 is provided inside the worm wheel 35, the size of the lens-drive mechanism 30 can be further reduced compared with the structure where the torque limiter mechanism is provided at another place. According to the above structure, the dimensions of the lens-drive mechanism 30 can be reduced in the direction along the rotational axis of the output shaft 33. Thereby, the size of the camera body 1 (camera) can be reduced.

Further, in the present invention, the clutch spring 36, for example, can also be configured so that the squeezing section 361 is expanded (the diameter of the squeezing section 361 is increased) when the pair of legs 362 is moved to separate from each other. In this case, the pair of stop members is disposed between the legs 362. Namely, the pair of legs 362 is arranged at both sides of the protuberance 355.

Further, in the present embodiment, although the inventive lens-drive mechanism is applied to a digital camera, application of the lens-drive mechanism is not limited to a digital camera, so that it can also be applied to a film camera and the like.

In the present embodiment, the worm wheel (ring member) 35 is included in the input part and the retainer (shaft member) 334 is included in the output part. However, this can be opposite, so that the retainer (shaft member) 334 can be included in the input part and the worm wheel (ring member) 35 can be included in the output part.

Further, in the present embodiment, the description is made for the torque limiter mechanism which is provided on the lens-drive mechanism of a camera. However, the torque limiter mechanism of the present embodiment can also be applied to a device other than the lens-drive mechanism of the camera.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2004-333688 (filed on Nov. 17, 2004) which is expressly incorporated herein, by reference, in its entirety.

1. A lens-drive mechanism for a camera, comprising:
a drive source;
an output shaft that is rotatable and comprises a joint which is connected to a lens barrel attached to a camera body, and which is rotated by a driving force from said drive source and transmits the rotation to said lens barrel through said joint; and
a power transmission system that transmits the driving force of said drive source to said output shaft, and which comprises a torque limiter mechanism that limits torque output from said output shaft;
wherein said power transmission system comprises a ring member through which said output shaft is inserted;
wherein said torque limiter mechanism comprises an elastic transmitting member that is coiled around said output shaft to contact said output shaft and that has two ends that protrude outside with respect to said output shaft, and a receiving portion that is provided on said ring member and which receives at least a part of said transmitting member;
wherein said receiving portion comprises a plurality of pairs of stop sections that are arranged along a periphery of said ring member and which are engageable with said both ends of said transmitting member, and spaces between each of said pairs of stop sections are different;
wherein said transmitting member is arranged so that said both ends of said transmitting member are engageable with a pair of the stop sections selected from said plurality of pairs of stop sections;
wherein said output shaft is connected to said ring member through said transmitting member and rotates with said ring member; and
wherein transmission of rotation of said output shaft is controlled when said transmitting member is expanded and one of said stop members abuts against one of said ends, when rotational speed of said output shaft is reduced or when the rotation of said output shaft is stopped, as a result of a force which is applied to said output shaft from the lens barrel side exceeding a predetermined value.

2. A lens-drive mechanism according to claim 1, wherein said drive source comprises a rotating shaft;
said power transmission system comprises a worm gear that is provided on a side of said rotating shaft of said drive source; and
said ring member comprises a worm wheel that engages said worm gear.

3. A lens-drive mechanism according to claim 1, wherein a torque limiter mechanism is provided inside said ring member.

4. A lens-drive mechanism according to claim 1, wherein said both ends of said transmitting member are disposed between said pair of said stop sections; and
wherein said transmitting member is so configured as to expand when said both ends are brought near to each other.

5. A lens-drive mechanism according to claim 1, wherein said transmitting member comprises a clutch spring.

6. A lens-drive mechanism according to claim 1, wherein said ring member is provided with a verifying system that enables verification of a position of said ends of said transmitting member with respect to said pair of stop sections, from outside said ring member.

7. A lens-drive mechanism according to claim 1, wherein said ring member is provided with an index that indicates order of the distance between each of said pairs of stop sections.

8. A lens-drive mechanism according to claim 1, wherein said ring member comprises a sidewall, a base plate having a hole through which said output shaft is inserted, and a plurality of protuberances that extend toward a center from an inner surface of said sidewall; and
wherein said stop sections are formed on both ends of each of said protuberances along a periphery of said ring member.

9. A lens-drive mechanism according to claim 8, wherein said transmitting member is received inside said sidewall.

10. A lens-drive mechanism according to claim 1, wherein said drive source comprises a motor.

11. A torque limiter mechanism, comprising:
an input part;
an output part; and
a transmitting member that transmits rotation of said input part to said output part;
wherein one of said input part and said output part comprises a ring member that is provided with a plurality of pairs of stop sections which are arranged along a periphery of said ring member, and the remaining one of said input part and said output part comprises a shaft inserted into said ring member;
wherein said transmitting member comprises a squeezing section that contacts said shaft and a pair of legs that is engageable with a pair of stop sections which is selected from said plurality of pairs of stop sections;
wherein when a torque that exceeds a predetermined value is induced between said input part and said output part while one of said legs is engaged with one of said pair of said stop sections which is selected from said plurality of pairs of said stop sections, a space between said legs is varied, so that a retaining force of said squeezing section to pinch said shaft is released or reduced; and
wherein each of said plurality of pairs of said stop sections is set at a different distance.

12. A torque limiter mechanism according to claim 11, wherein said transmitting member comprises a torsion coil spring, and said squeezing section is a section of said torsion coil spring which is coiled around said shaft, and further, said legs are both ends of said torsion coil spring and protrude outside of said shaft.

13. A torque limiter mechanism according to claim 11, wherein said ring member comprises a sidewall and a plurality of protuberances that extend toward a center from an inner surface of said sidewall; and
wherein said stop sections are formed on both ends of each of said protuberances along a periphery of said ring member.

14. A torque limiter mechanism according to claim 11, wherein said torque limiter mechanism is provided in a lens-drive mechanism of a camera.
